(19) United States
(12) Patent Application Publication
(10) Pub. No.: US 2025/0309582 A1
(43) Pub. Date: Oct. 2, 2025

(54) WATER-RESISTANT ENCLOSURES FOR ELECTRICAL UNITS

(71) Applicant: EATON INTELLIGENT POWER LIMITED, DUBLIN 4 (IE)

(72) Inventors: CHUANCHUAN ZHUANG, Shanghai (CN); ERIK J. GOUHL, Fayetteville, GA (US); LUIS F. SALAS, Fayetteville, GA (US); KUN ZHONG, Shanghai (CN)

(73) Assignee: EATON INTELLIGENT POWER LIMITED, DUBLIN 4 (IE)

(21) Appl. No.: 19/091,135

(22) Filed: Mar. 26, 2025

Related U.S. Application Data
(60) Provisional application No. 63/570,363, filed on Mar. 27, 2024.

(51) Int. Cl. H01R 13/52; H01R 13/10; H01R 13/506; H01R 13/66; H01R 13/74; H01R 103/00

(52) U.S. Cl. CPC H01R 13/52; H01R 13/10; H01R 13/506; H01R 13/6658; H01R 13/748; H01R 2103/00

(57) ABSTRACT

Disclosed herein are water-resistant housings for an electrical outlet. The water-resistance of the housings is implemented via interlocking step structured connections between sub-housings of the main housing. In one example, a water-resistant housing assembly may include a top and bottom housings each having perimeters formed of outer ridges and inner grooves, and a middle housing having a top middle perimeter and a bottom middle perimeter, the top middle perimeter and the bottom middle perimeter comprising respective inner ridges and outer grooves. In some examples, the middle housing is configured to form water-resistant connections with the bottom housing and the top housing via forming a interlocking step structure between the inner ridges and the outer grooves the corresponding outer ridges and inner grooves of the bottom housing and the top housing.

### CROSS-REFERENCE TO RELATED APPLICATION

This application claims priority to U.S. Provisional Patent Application Ser. No. 63/570,363, filed on Mar. 27, 2024 and titled “GROUND FAULT CIRCUIT INTERRUPTER RECEPTACLE WITH WATER RESISTANCE STRUCTURES,” the entire contents of which are incorporated herein by reference.

### TECHNICAL FIELD

The present disclosure is directed to enclosures for electrical outlets and, in particular, to an electrical outlet having an enclosure sealed off from the external environment to reduce or even eliminate the entry of fluids, particles, and/or the like into an internal portion of the electrical outlet.

### BACKGROUND

Electrical outlets include internal circuitry, wires, terminals, and other components arranged within a housing. These components are necessary to provide power to connected devices. Specialized outlets, such as circuit interrupter outlets, include additional elements arranged within the housing to implement safety features that protect against fault conditions. For example, a ground fault circuit interrupter (GFCI) outlet may include moveable components to open/close separable contacts, current sensors, solenoids, a printed circuit board assembly (PCBA), control chips, and/or the like.

The internal components of an electrical outlet are susceptible to failure and damage if water, particles, or other environmental elements reach inside the outlet. Conventional housings provide a standardized, minimum level of protection against the ingress of unwanted environmental elements. However, this minimum level of protection is often inadequate if the outlet is exposed to environmental elements. For example, standard housings are prone to moisture (for example, water droplets) that enter the housings, resulting in short circuits and/or other failures caused by the entry of moisture. Large, bulky enclosures with doors, rubber gaskets, and/or other moisture barriers have been developed, particularly for outside applications. However, such thick, bulky outlets consume valuable structural space, are more expensive, and are difficult and time-consuming to install.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

In one embodiment, a water-resistant housing assembly for an electrical outlet may include a top housing having a top housing perimeter, a bottom housing having a bottom housing perimeter, the bottom housing perimeter and the top housing perimeter formed with respective outer ridges and inner grooves, and a middle housing having a top middle perimeter formed on a top side of the middle housing and a bottom middle perimeter arranged on a bottom side of the middle housing, the top middle perimeter and the bottom middle perimeter comprising respective inner ridges and outer grooves. The middle housing may be configured to form a first connection to the top housing in a first water-resistant connection via forming a first interlocking step structure between the inner ridges and the outer grooves of the top middle perimeter and the outer ridges and the inner grooves of the top housing perimeter, and form a second connection to the bottom housing in a second water-resistant connection via forming a second interlocking step structure between the inner ridges and the outer grooves of the bottom middle perimeter and the outer ridges and the inner grooves of the bottom housing perimeter.

In some embodiments of the water-resistant housing assembly, each of the inner ridges and each corresponding one of the inner grooves are orientated at ninety degrees with respect to each other.

In various embodiments of the water-resistant housing assembly external seams are formed at the first connection and the second connection, and the inner ridges and outer grooves form a tortuous path for environmental elements to enter an interior of the water-resistant housing assembly.

In some embodiments of the water-resistant housing assembly, the middle housing and the bottom housing form a compartment configured to house electrical components of the electrical outlet.

In exemplary embodiments of the water-resistant housing assembly, each of the inner ridges and the outer ridges include ridge surfaces are configured to abut against corresponding groove surfaces of the inner grooves and the outer grooves.

In various embodiments of the water-resistant housing assembly, the bottom housing comprises a bottom sidewall extending longitudinally upward from a base of the bottom housing, the bottom sidewall having a water-resistant bottom recess, the middle housing includes a water-resistant middle recess arranged in a middle sidewall of the middle housing, and the water-resistant bottom recess and the water-resistant middle recess configured to be coupled to form a water-resistant recess for a connecting mechanism of a terminal arranged within the electrical outlet.

In some embodiments of the water-resistant housing assembly, the water-resistant middle recess includes a first water-resistant surface and a first water-resistant step-structured bottom portion, and the water-resistant bottom recess includes a second water-resistant surface and a second water-resistant step-structured bottom portion.

In various embodiments of the water-resistant housing assembly, the first water-resistant surface, the first water-resistant step-structured bottom portion, the second water-resistant surface, and the second water-resistant step-structured bottom portion are configured to form a water-resistant step structure.

In some embodiments of the water-resistant housing assembly, the water-resistant middle recess comprises water-resistant teeth and water-resistant inner surfaces configured to correspond with upper contours of the terminal to prevent a gap between the terminal and the middle recess.

In one embodiment, and electrical outlet may include a top housing, a bottom housing including a base, bottom corners, and bottom sidewalls extending upwardly from the base, the base, the bottom corners and the bottom sidewalls forming a compartment structured to house electrical components of the electrical outlet, a middle housing having a platform including middle corners and middle sidewalls extending longitudinally downward from the platform, the middle housing coupled to the top housing on a top surface of the platform and coupled to the bottom housing on a bottom surface of the platform, the middle housing being structured to cover the compartment, and load terminals arranged within the compartment and configured to be coupled to connecting mechanisms, wherein the top housing, the middle housing, and the bottom housing are coupled via interlocking step structures to form a water-resistant structure.

In some embodiments of the electrical outlet, the bottom sidewalls comprise water-resistant bottom recesses structured to receive the connecting mechanisms and the middle sidewalls comprise water-resistant middle recesses structured to receive upper portions of the connecting mechanisms, the water-resistant bottom recesses and the water-resistant middle recesses to form a portion of the water-resistant structure.

In exemplary embodiments of the electrical outlet, the water-resistant bottom recesses of the bottom sidewalls include water-resistant surfaces and water-resistant step-structured upper portions, and wherein the water-resistant middle recesses of the middle sidewalls include water-resistant surfaces and water-resistant step-structured bottom portions.

In various embodiments of the electrical outlet, the water-resistant surfaces of the bottom recesses are structured to engage with the connecting mechanisms, the load terminals, and respective water-resistant surfaces of the middle recesses to form a portion of the water-resistant structure.

In some embodiments of the electrical outlet, the water-resistant step-structured upper portions of the bottom recesses are structured to engage with the water-resistant step-structured bottom portions of the middle recesses to form a portion of the water-resistant structure.

In exemplary embodiments of the electrical outlet, the bottom corners comprise water-resistant step-structured upper portions each including water-resistant surfaces, wherein the middle corners comprise water-resistant bottom surfaces, and wherein the platform includes water-resistant edges on the bottom surface of the platform and non-water-resistant projections extending downwardly at an inner periphery of the water-resistant edges, the non-water-resistant projections including water-resistant external side surfaces.

In various embodiments of the electrical outlet, the water-resistant step-structured upper portions of the bottom corners are structured to engage with the water-resistant bottom surfaces of the middle corners and the water-resistant external side surfaces of the non-water-resistant projections of the platform to form a portion of the water-resistant structure.

In some embodiments of the electrical outlet, the water-resistant structure has a step-structure including a plurality of water-resistant steps configured to operate as a tortuous path for environmental elements to ingress into the housing assembly.

In one embodiment, a ground fault circuit interrupter (GFCI) outlet may include a load terminal and a line terminal and a water-resistant housing assembly having the load terminal and the line terminal arranged therein. The water-resistant housing assembly may include a top housing having a top housing perimeter, a bottom housing having a bottom housing perimeter, the bottom housing perimeter and the top housing perimeter formed with respective outer ridges and inner grooves, and a middle housing having a top middle perimeter formed on a top side of the middle housing and a bottom middle perimeter arranged on a bottom side of the middle housing, the top middle perimeter and the bottom middle perimeter comprising respective inner ridges and outer grooves. The middle housing may be configured to form a first connection to the top housing in a first water-resistant connection via forming a first interlocking step structure between the inner ridges and the outer grooves of the top middle perimeter and the outer ridges and the inner grooves of the top housing perimeter, and form a second connection to the bottom housing in a second water-resistant connection via forming a second interlocking step structure between the inner ridges and the outer grooves of the bottom middle perimeter and the outer ridges and the inner grooves of the bottom housing perimeter. The bottom housing may include a water-resistant bottom recess and the middle housing includes a water-resistant middle recess, the water-resistant bottom recess and the water-resistant middle recess configured to be coupled to form a water-resistant recess for a connecting mechanism of one of the load terminal or the line terminal.

In some embodiments of the GFCI outlet, the external seams are formed at the first connection and the second connection, and the inner ridges and outer grooves form a tortuous path for environmental elements to enter an interior of the water-resistant housing assembly.

In various embodiments of the GFCI outlet, wherein the middle housing and the bottom housing form a compartment configured to house electrical components of the electrical outlet.

In one embodiment, a GFCI receptacle includes a top housing; a bottom housing including a base, bottom corners and bottom sidewalls extending upwardly from the base and adjoining respective bottom corners, the base, the bottom corners and the bottom sidewalls forming a compartment structured to house a printed circuit board assembly including a circuit interruption mechanism; a middle housing having a platform and affixed to the top housing on a top surface of the platform and to the bottom housing on a bottom surface of the platform, the middle housing being structured to cover the compartment, the middle housing further including middle corners and middle sidewalls extending downwardly from the platform and adjoining respective middle corners; and load terminals disposed within the compartment and structured to be connected to respective loads via connecting mechanisms, where the middle housing, the bottom housing and the load terminals form a water-resistant structure that minimizes moisture ingress to the compartment.

### BRIEF DESCRIPTION OF THE DRAWINGS

By way of example, features of the disclosed components and systems are described with reference to the accompanying drawings, in which:

FIG. 1 depicts an illustrative example of an electrical outlet including a housing assembly in accordance with the present disclosure;

FIG. 2 depicts an illustrative example of a bottom housing in accordance with the present disclosure;

FIGS. 3A and 3B depict an illustrative example of a middle housing in accordance with the present disclosure;

FIG. 4 depicts an illustrative example of a top housing in accordance with the present disclosure;

FIGS. 5A and 5B depict illustrative examples of a transparent middle housing installed on a bottom housing in accordance with the present disclosure;

FIGS. 6A and 6B depict illustrative examples of cross-sectional views of a housing assembly in accordance with the present disclosure; and

FIG. 7 depicts an illustrative example of an interlocking step structure in accordance with the present disclosure.

### DETAILED DESCRIPTION

Various features of an improved housing assembly of an electrical outlet, unit, or device are described in the present disclosure, with reference to the accompanying drawings, in which one or more features of the housing assembly and the electrical outlet that includes the housing assembly are shown and described. The various features described in the present disclosure and depicted in the accompanying drawings may be used independently of, or in combination, with each other. A housing assembly and electrical outlet as disclosed herein may be embodied in many different forms and should not be construed as being limited to the examples set forth herein. Rather, these examples are provided to convey certain features of the housing assembly and electrical outlet to those skilled in the art.

In some embodiments, the electrical outlet may be or may include a circuit interrupter electrical outlet. In various embodiments, the electrical outlet may be or may include a ground fault circuit interrupter (GFCI) outlet. Although examples of the present disclosure include an electrical outlet in the form of a GFCI outlet, embodiments are not so limited, for instance, the housing assembly, portions thereof, and/or components thereof may be used with other existing or future-developed electrical outlets.

In some embodiments, the housing assembly may be configured as an enclosure structure for the internal components of an electrical outlet. A housing assembly in accordance with some embodiments described in the present disclosure may include various water-resistant structures. The water-resistant structures may be configured to impart water-resistant properties to at least a portion of the housing assembly to prevent water, moisture, and/or the like from entering the housing assembly and penetrating the interior of the electrical outlet. Accordingly, housing assemblies according to some embodiments may be water-resistant.

Although the term “water,” “water droplets,” and “water-resistant” are used in the present disclosure, embodiments are not limited to liquid water. The term “water-resistant,” “water-tight,” and/or the like generally means resistant to ingress by environmental elements external to the electrical outlet. Non-limiting examples of environmental elements may include water, water droplets, moisture, water vapor, fluids, dust, dirt, particles, gas, air, variations thereof, combinations thereof, and/or the like. In some embodiments, certain portions of the housing assembly may be hermetically or partially hermetically sealed from the external environment. In various embodiments, water-resistant portions of the housing assembly may provide a tortuous path for moisture that reduces or even completely eliminates ingress of moisture into an interior of the housing assembly through the water-resistant portions.

In various embodiments, the housing assembly may be formed of one or more sub-housings, such as a top housing, a middle housing, and/or a bottom housing. The sub-housings may include connecting elements, such as edges, projections, sidewalls, and/or the like, that allow the sub-housings to connect with each other. In some embodiments, portions of the connections between the sub-housings may be water-resistant. In various embodiments, the connecting elements may facilitate a friction-fit, interference-fit, press-fit, and/or the like between at least portions of the sub-housings.

For example, in some embodiments, one or more interlocking connections may be formed between the sub-housings. In various embodiments, the interlocking connections may be or may include step structures formed via ridges being arranged within corresponding (one-sided) grooves. The grooves may include groove surfaces configured to interface with ridge surfaces to form the step structure. The step structure may form a friction-fit and/or the like between sub-housings, for instance due to the friction between ridges and grooves. The friction-fit may provide water-resistance between sub-housings. In some embodiments, the step structure may operate to provide a tortuous path between sub-housings for the ingress of environmental elements to provide and/or to further facilitate water-resistance between sub-housings. For example, a wall (for instance, formed by a groove) may be directly behind each seam between coupled sub-housings. Accordingly, for moisture, water droplets, or other environmental elements to enter a seam in the housing assembly, it must travel past the corresponding ridges and grooves in order to penetrate the interior of the housing assembly, which may not be possible under typical environmental conditions, including when exposed to moisture or other environmental elements.

The housing assembly of the described embodiments may provide multiple technological advantages over existing electrical outlet housings. In one non-limiting technological advantage, the housing assembly may allow for a water-resistant electrical outlet housing. For example, in some embodiments, the housing assembly may prevent the ingress of environmental elements, including moisture, water droplets, and/or the like between sub-housings. In another non-limiting technological advantage, the housing assembly may provide for a water-resistant enclosure, particularly between sub-housing connection seams, in a smaller and/or slimmer form factor than available through existing systems, such as electrical outlets using sealing gaskets, doors, covers, and/or the like.

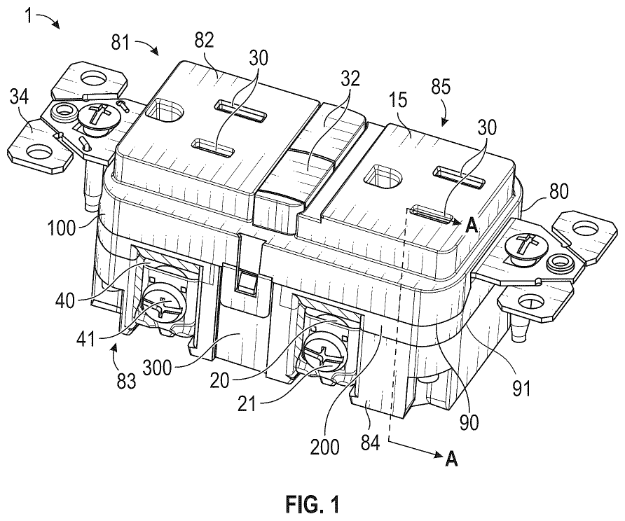

FIG. 1 depicts an illustrative example of an electrical outlet including a housing assembly in accordance with the present disclosure. The electrical outlet components are depicted in FIG. 1 for illustrative purposes. Electrical outlets and components thereof in accordance with the present disclosure may include more or fewer components and/or may be arranged in a different configuration.

As shown in FIG. 1, an electrical outlet 1 may be or may include a GFCI outlet. The GFCI outlet 1 may include a housing assembly (for instance, a frame or enclosure) 15 formed of one or more sub-housings. In some embodiments, the sub-housings may include a top housing (or cover) 100, a middle housing 200, and/or a bottom housing 300. In various embodiments, the sub-housings 100, 200, and 300 may connect together, at least partially, via a friction-fit, interference-fit, press-fit, snap-fit, and/or the like alone or in combination with other connection types, such as fasteners, clips, and/or the like. In some embodiments, seams 90 and 91 may be formed between the connected sub-housings 100, 200, and/or 300. The seams 90 and 91 may be external seams on an external surface of the housing assembly 15.

The top housing 100 may include electrical slots, outlets, or electrical inlets 30 configured to receive corresponding prongs of a prong connector or plug. Although the present disclosure, including FIG. 1, describes the GFCI outlet 1 as having double outlets 30, embodiments are not so limited, as this configuration is for illustrative purposes only. For example, the GFCI outlet 1 may include more or fewer electrical outlets 30. The GFCI outlet 1 may include load terminals 40 and line terminals 20 for coupling the GFCI outlet 1 to corresponding load and line connections via connecting mechanisms 41 and 21, respectively. In various embodiments, one or more plates 42 and 22 may be associated with the connecting mechanisms 41 and 21, for example, and without limitation, to provide stability and/or the like to the installed connecting mechanisms 41 and 21. The GFCI outlet 1 may include one or more function buttons (or actuators) 32, such as a RESET button and/or a TEST button.

In the present disclosure, the sides of the GFCI outlet 1 are described with reference to a typical installation, with a top side 80, a bottom side 81, a front side 82 (facing outward from an installation wall), a back side 83 (in the installation wall), a first longitudinal (or right) side 84, and a second longitudinal (or left) side 85. The sides 80-85 are for non-limiting reference to describe directionality of certain components and/or operations of the embodiments, for example, a GFCI outlet 1 may be installed in a different configuration in which side 80 is the bottom and side 81 is the top.

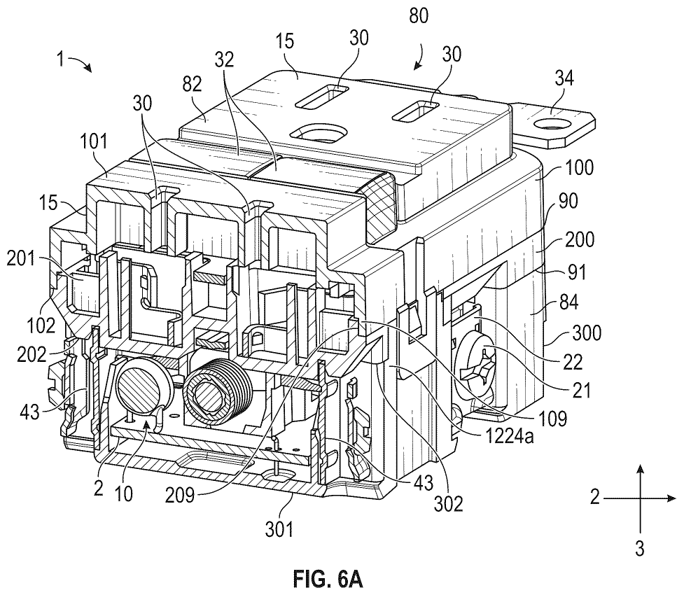

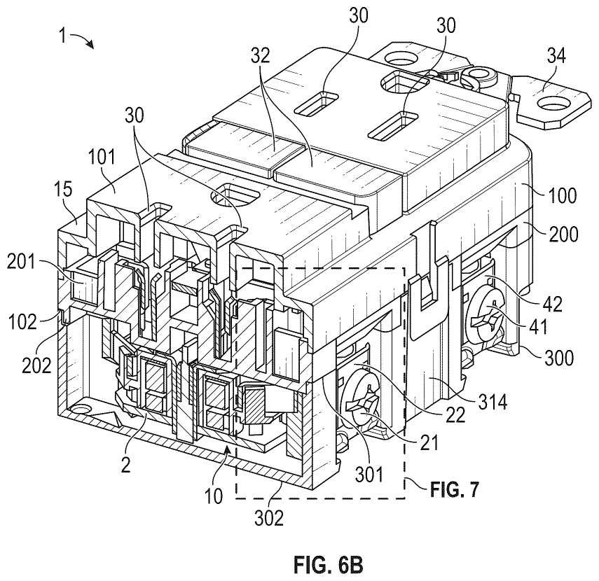

In addition, in the present disclosure, the relative positions and movements of components may be described with reference to a longitudinal axis and a lateral axis orthogonal to the longitudinal axis (see, for example, the longitudinal axis 3 and the lateral axis 2 as depicted in FIG. 6). The term “longitudinally higher” means longitudinally closer to the top housing 100 and “longitudinally lower” means longitudinally further away from the top housing 100. In a typical installation configuration, longitudinally lower may be “behind” from the perspective of an external viewer viewing the top housing 100. “Longitudinally upward” means longitudinally toward the top housing 100 (and away from the bottom housing 300). In a typical installation configuration, longitudinally upward may be “in front of” from the perspective of an external viewer viewing the top housing 100. “Longitudinally downward” means longitudinally away from the top housing 100 (and toward the bottom housing 300). Moving longitudinally 3 generally indicates movement from front to back (for example, from the front side 82 to the back side 83), or vice versa. Moving laterally 2 generally indicates movement from right to left (for example, from the first longitudinal (or right) side 84 to the second longitudinal (or left) side 85), or vice versa.

Although the GFCI outlet 1 is described with sub-housings 100, 200, and 300 having four sidewalls and four corners, embodiments are not so limited. For example, the sub-housings 100, 200, and 300 may include more or less sidewalls, corners, cut-outs, recesses, and/or the like without departing from the scope of the present disclosure.

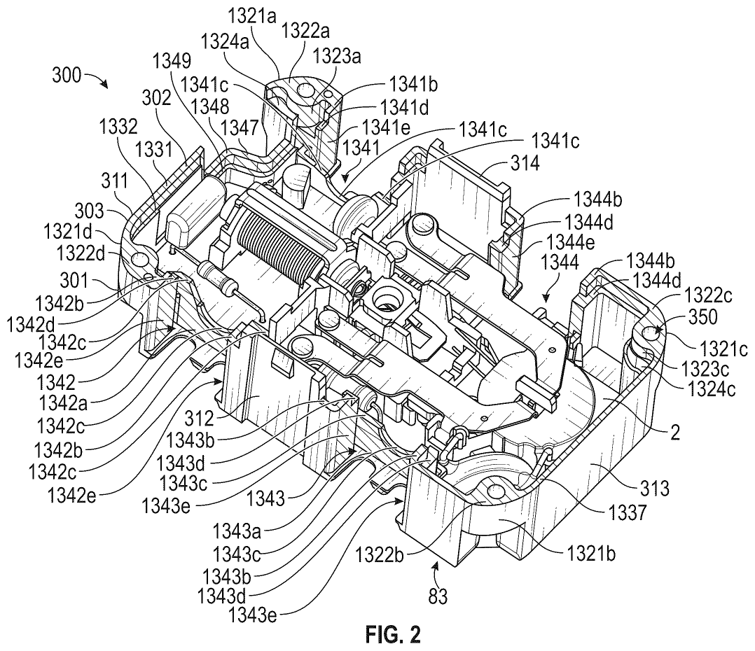

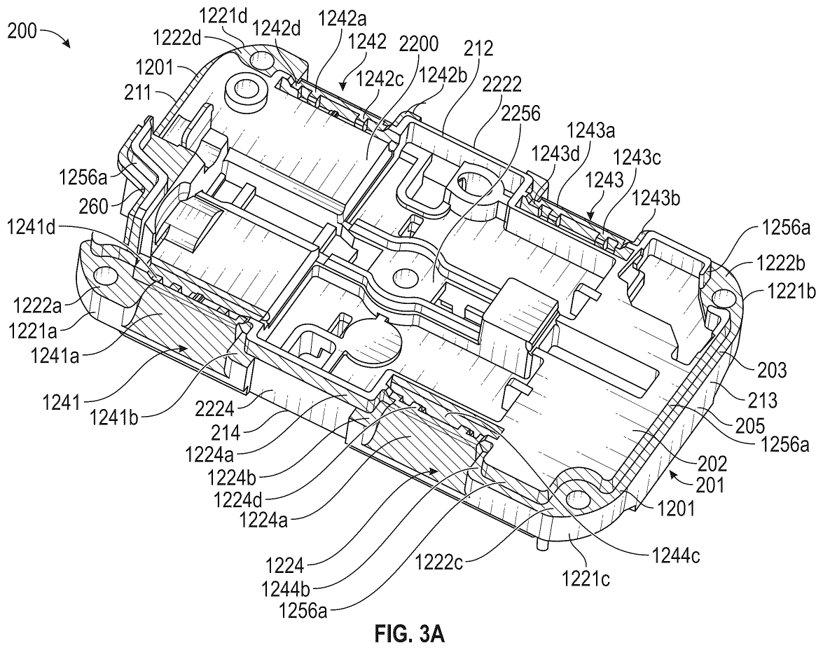

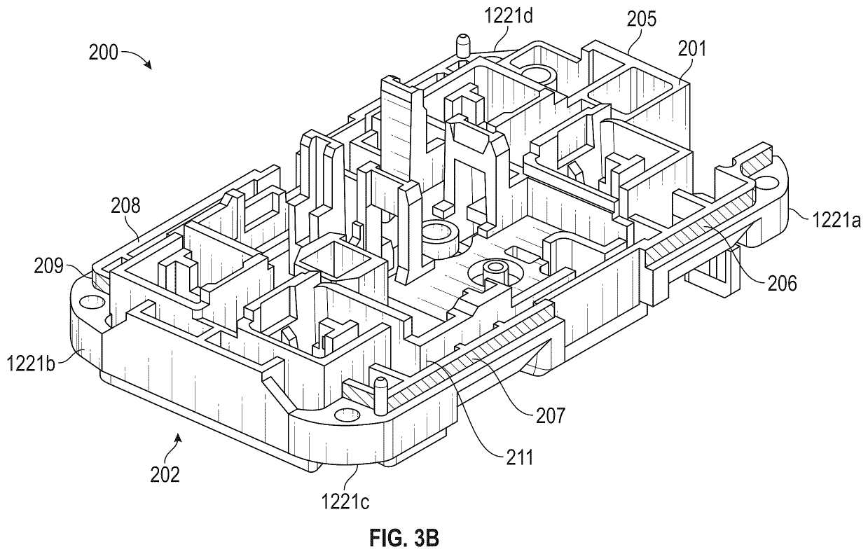

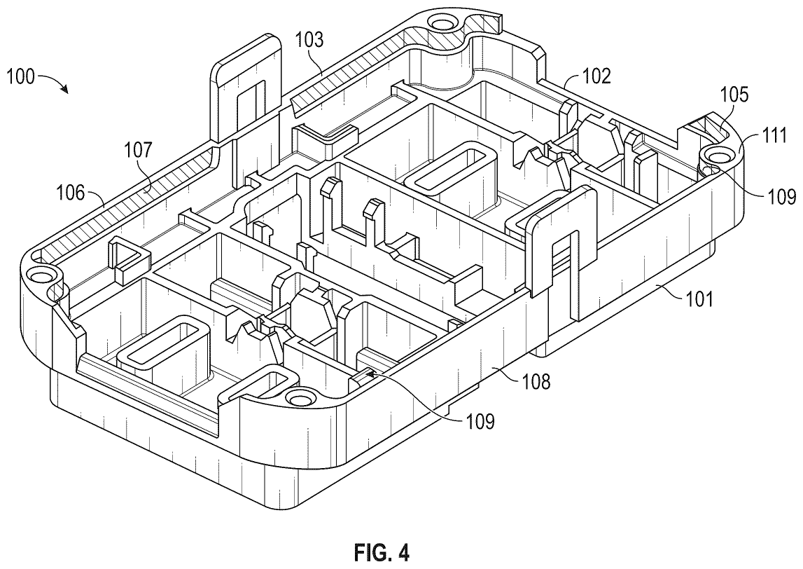

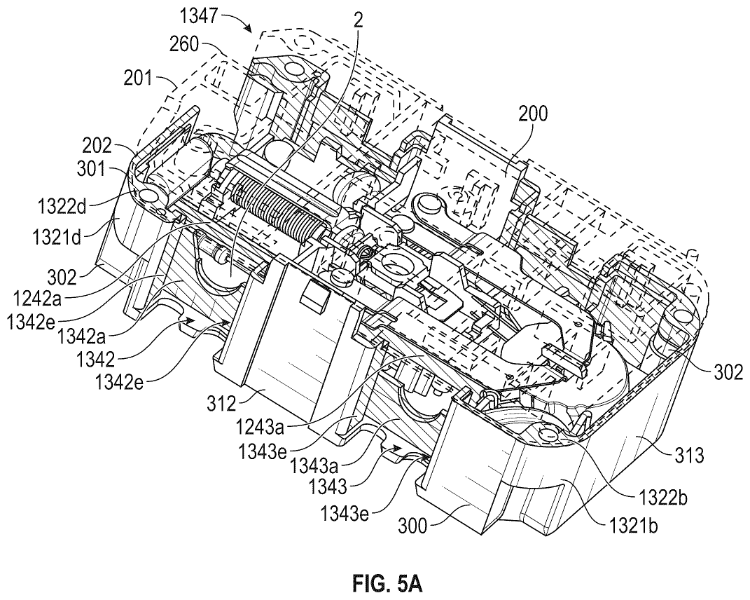

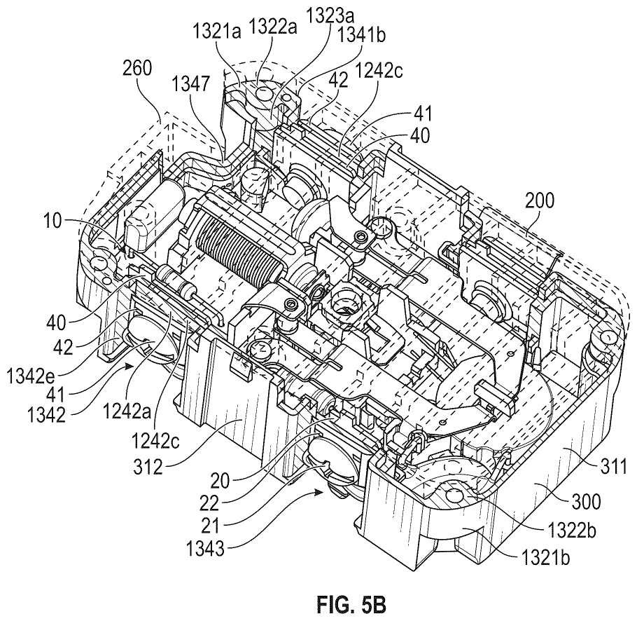

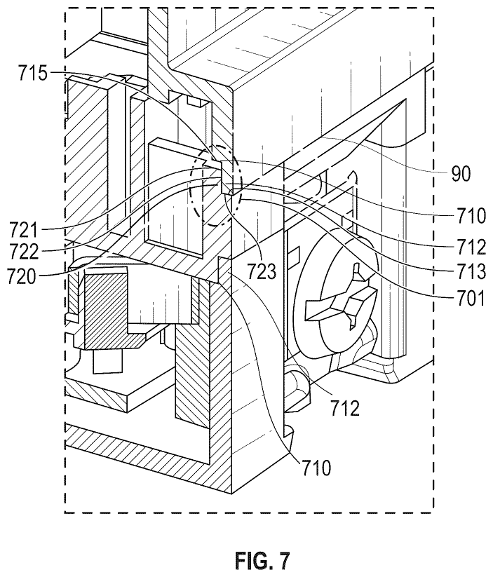

With reference to FIGS. 2-7, various features of exemplary embodiments are described in the present disclosure in which FIGS. 2-4 depict various views of the sub-housings 100, 200, and 300 of the GFCI outlet 1 in accordance with the present disclosure. More specifically, FIG. 2 depicts an illustrative example of the bottom housing 300; FIGS. 3A and 3B depict illustrative examples of the bottom and top of the middle housing 200, respectively; and FIG. 4 depicts an illustrative example of the top housing 100. FIGS. 5A and 5B depict illustrative examples of a transparent middle housing 200 installed on a bottom housing 300 in accordance with the present disclosure. FIGS. 6A-7 depict illustrative examples of cross-sectional views of a housing assembly in accordance with the present disclosure.

Referring to FIGS. 2-7, surfaces hatched with diagonal lines (for instance, references 1337 and 1342a in FIGS. 2 and 1224a in FIG. 3A) indicate water-resistant surfaces configured to form water-resistant structures (for instance, water-resistant connections) between sub-housings 100, 200, and 300 and/or portions thereof. In various embodiments, the water-resistant surfaces of the sub-housings 100, 200, and 300 may be made from or may include various water-resistant, pliable, flexible, and/or polymer materials operative to facilitate a water-resistant connection between the sub-housings 100, 200, and 300 (compared with conventional GFCI outlet 1 plastic materials).

As shown in FIG. 2, the bottom housing 300 may have various outlet elements arranged on or within the space defined by the bottom housing 300. Certain outlet elements may be directly coupled to the bottom housing 300, such as to an inner bottom surface of the bottom housing 300. For example, a PCBA board 2 may be coupled to the inner bottom surface of the bottom housing. Non-limiting examples of other outlet components may include contacts, moveable arms, solenoids, coils, current sensors, and/or the like.

The bottom housing 300 may include a water-resistant perimeter 303 (indicated by surfaces hatched with diagonal lines) configured to form a water-resistant connection with a corresponding water-resistant perimeter 203 of the middle housing 200.

In some embodiments, the bottom housing 300 may include one or more openings 350 configured to receive corresponding projections of the middle housing 200, for example, to facilitate coupling of the middle housing 200 to the bottom housing 300.

In various embodiments, the bottom housing 300 may include a base 301 (for instance, a bottom surface or floor), bottom corners 1321a, 1321b, 1321c, and 1321d, and bottom sidewalls 311, 312, 313, and 314 extending upwardly from the base 301. In some embodiments, bottom sidewalls 311, 312, 313, and 314 may adjoin or partially respective bottom corners 1321a, 1321b, 1321c, and 1321d with water-resistant bottom recesses 1342, 1343, 1341, and 1344 arranged therebetween. For example, a first bottom sidewall 311 extends upwardly from the base 301 and adjoins bottom corners 1321a and 1321d. A second bottom sidewall 312 extends upwardly from the base 301 and adjoins bottom corners 1321d and 1321b. A third bottom sidewall 313 extends upwardly from the base 301 and adjoins bottom corners 1321b and 1321c. A fourth bottom sidewall 314 extends upwardly from the base 301 and adjoins bottom corners 1321c and 1321a. The bottom sidewalls include non-terminal sidewalls 311 and 313 and terminal sidewalls 312 and 314 configured to connect the load and line terminals 40 and 20 to respective load and power lines via the connecting mechanisms 41 and 21, respectively. Non-limiting examples of connecting mechanism 41 and 21 may include screws, fasteners, and/or the like.

The non-terminal sidewalls 311 and 313 each include water-resistant step-structured upper portions 1331 and 1337, respectively, configured to engage or be affixed to respective water-resistant edges 1201 and external surfaces 1256a of the platform 205 of the middle housing 200 so as to form water-resistant connections therebetween (see, for example, FIG. 3A). The non-terminal sidewalls 311 and 313 may also be configured to connect the GFCI outlet 1 within a wall inbox (not shown) when the GFCI outlet is physically installed in a structure.

Terminal sidewalls 312 and 314 include water-resistant bottom recesses 1342, 1343, 1341, and 1344 structured to receive the connecting mechanisms 41 and 21. Each bottom recess 1342, 1343, 1341, and 1344 may include: a water-resistant surface 1342a, 1343a, 1341a, and 1344a; a water-resistant step-structured upper portion 1342b, 1343b, 1341b, and 1344b; a terminal opening water-resistant portion 1342c, 1343c, 1341c, and 1344c; a water-resistant step-structured lower portion 1342d, 1343d, 1341d, and 1344d; and water-resistant side walls 1342e, 1343e, 1341e, and 1344e.

The water-resistant surfaces 1342a, 1343a, 1341a, and 1344a are structured to engage with the connecting mechanisms 41 and 21, the load and line terminals 40 and 20, and respective water-resistant surfaces 1241a, 1244a, 1243a, and 1242a of the middle recesses 1241, 1244, 1242, and 1243 in a water-resistant manner. By making the surfaces 1342a, 1343a, 1341a, and 1344a of the bottom recesses 1342, 1343, 1341, and 1344 water-resistant, when the load and line terminals 40 and 20 are connected to respective load and power lines via the connecting mechanisms 41 and 21, the water-resistant bottom recesses 1342, 1343, 1341, and 1344 interface with the connecting mechanisms 41 and 21, the load and line terminals 40 and 20 and respective middle recesses 1241, 1244, 1242, and 1243 in a water-resistant manner as shown in FIGS. 5A and 5B such that moisture penetration through the bottom recesses 1342, 1343, 1341, 1344, the connecting mechanisms 41 and 21, the load and line terminals 40 and 20, and the respective middle recesses 1241, 1244, 1242, and 1243 is significantly reduced, minimized, or even completely eliminated compared to conventional GFCI outlets, including for example, conventional GFCI outlets having terminal sidewalls without the exemplary water-resistant recesses. The water-resistant step-structured upper portion 1342b, 1343b, 1341b, and 1344b of the bottom recesses 1341, 1342, 1343, and 1344 are structured to engage with respective water-resistant step-structured bottom portion 1241b, 1242b, 1243b, and 1244b of water-resistant recesses 1241, 1242, and 1243, 1244 of the middle housing 200. By making the upper portions 1342b, 1343b, 1341b, and 1344b of the recesses 1342, 1343, 1341, and 1344 to have water-resistant step-structures, the GFCI outlet 1 allows the step-structures of the upper portions 1342b, 1343b, 1341b, and 1344b of the bottom housing 300 to engage with respective step-structures 1241b, 1242b, 1243b, and 1244b of the middle housing 200 in a water-resistant manner such that moisture penetration through the engaging middle and bottom housing surfaces is reduced, minimized, or even completely eliminated compared to conventional GFCI outlets, including for example, conventional GFCI outlets having terminal sidewalls without the exemplary water-resistant recesses.

In some examples, the terminal sidewalls 312 and 314 include non-water-resistant portions 2322 and 2324 between the water-resistant bottom recesses 1342, 1343, 1341, and 1344 for example, and without limitation, structural integrity. In some examples, the external surfaces of the sidewalls 311, 312, 313 and 314 and the base 301 of the bottom housing 301 may be non-water-resistant, for example, and without limitation, structural integrity. In some examples, a non-terminal sidewall 311 may include an internally indented portion 1347 with a water-resistant step-structured upper portion 1348 having a height lower than remaining portion of that non-terminal sidewall 311 so as to accommodate different connecting mechanism or components of the GFCI outlet 1 in a non-water-resistant manner. In various embodiments, as shown in FIG. 3A, the middle housing 200 may include an indented portion 260 corresponding with the indented portion 1347.

In some examples, non-water-resistant projections (only the projections 2362 and 2364 are shown in FIG. 3A) may extend outwardly from the platform 205 and the connecting mechanism 41 and 21 may be disposed on top thereof for example, and without limitation, to facilitate a stable connection.

The bottom corners 1321a, 1321b, 1321c, and 1321d each include water-resistant step-structured portions 1322a, 1322b, 1322c, and 1322d with upper portions (only the upper portions 1323a and 1323c are shown in FIG. 2) and lower portions (only the lower portions 1324a and 1324c are shown in FIG. 2). The water-resistant step-structured upper portions (for example, 1323a and 1323c) are structured to engage with respective water-resistant bottom surfaces 1222a, 1222b, 1222c, and 1222d of the middle corners 1221a, 1221b, 1221c, and 1221d and the external side surfaces 1256a of the projections 2256 of the middle housing 200. As such, when the water-resistant structures of the middle and bottom corners engage, they form water-resistant connections therebetween such that moisture penetration through the connections is reduced, minimized, or even completely eliminated compared to conventional GFCI outlets.

Referring to FIG. 3A, therein is depicted the bottom side 202 of the base 205 configured to connect with the bottom housing 300. The middle housing 200 may include the platform 205, middle corners 1221a, 1221b, 1221c, and 1221d, and middle sidewalls 211, 212, 213, and 214 extending downwardly from the platform 205 and adjoining respective middle corners 1221a, 1221b, 1221c, and 1221d.

The platform 205 includes water-resistant edges 1201 and a non-resistant portion 2200 including projections 2256 extending downwardly at an inner periphery of the water-resistant edges 1201. The projections 2256 have water-resistant external side surfaces 1256a. The water-resistant edges 1201 of the platform 205 and the external side surfaces 1256a of the projections 2256 are structured to engage with respective water-resistant step-structured upper portions (for example, 1332) of respective bottom sidewalls (for example, 1331 and 1337) so as to form water-resistant connections therebetween. The middle sidewalls 211, 212, 213, and 214 extend downwardly at the outer periphery of the water-resistant edges 1201, and include terminal sidewalls 212 and 214 structured to connect the load and line terminals 40 and 20 to respective load and power lines via the connecting mechanism 41 and 21. The sidewalls 211 and 213 may be non-terminal sidewalls and structured to connect the GFCI outlet 1 within a wall inbox (not shown).

Terminal sidewalls 212 and 214 include water-resistant recesses 1241, 1244, 1242, and 1243 structured to receive upper portions of the connecting mechanism 41 and 21. Each recess 1241, 1244, 1242, and 1243 includes a water-resistant surface 1241a, 1244a, 1243a, and 1242a. When the load and line terminals 40 and 20 are connected to the connecting mechanisms 41 and 21, the water-resistant recesses 1241, 1244, 1242, and 1243 interface with the upper portions of the connecting mechanisms 41 and 21, the load and line terminals 40 and 20 and with respective water-resistant bottom recesses 1341, 1344, 1342, and 1343 in a water-resistant manner as shown in FIGS. 5-7. Each recess 1241, 1244, 1242, and 1243 also includes a water-resistant step-structured bottom portion (only the bottom portions 1241b and 1244b are shown in FIG. 3A) structured to engage with respective water-resistant step-structured upper portion 1341b, 1342b, 1343b, and 1344b of water-resistant bottom recesses 1341, 1342, 1343, and 1344 of the bottom housing 300 in a water-resistant manner. In some examples, each water-resistant middle recess 1241, 1242, 1243, and 1244 may also include water-resistant teeth 1241d, 1242d, 1243d, and 1244d and/or water-resistant inner surfaces 1241c, 1242c, 1243c, and 1244c structured to fit with upper contours of load and line terminals 40 and 20 such that any gap between the terminals 40 and 20 and the middle recesses 1241, 1244, 1242, and 1243 may be reduced or eliminated so as to make the connections therebetween water-resistant.

In some examples, the terminal sidewalls 212 and 214 include non-water-resistant portions 2222 and 2224 between the water-resistant middle recesses 1241, 1244, 1242, and 1243 for, for example, and without limitation, structural integrity. However, the non-water-resistant portions 2222, 2224 also include water-resistant upper portions (only the upper portion 1224a is shown in FIG. 3A) such that when the non-water-resistant portions 2222 and 2224 of the middle housing 200 engage with the non-water-resistant portions 2322 and 2324 of the bottom housing 300, the connections therebetween remain water-resistant.

The middle corners 1221a, 1221b, 1221c, and 1221d each include water-resistant bottom surfaces 1222a, 1222b, 1222c, and 1222d structured to engage with respective water-resistant top surfaces 1322a, 1322b, 1322c, and 1322d of the water-resistant step-structured upper portions (for example, 1323a and 1323c) of the bottom housing 300 so as to form water-resistant connections therebetween. The external surfaces of the middle corners 1221a, 1221b, 1221c, and 1221d may be non-water-resistant, for example, and without limitation, structural integrity.

In some embodiments, the top housing 100 and the middle housing 200 may be coupled in a water-resistant configuration. Referring to FIGS. 3B and 4, the middle housing 200 includes an upper portion 201 disposed on an upper surface 201 of the platform 205 and includes one or more sidewalls 206 and 208 having water-resistant external surfaces 207 and 209. As shown in FIG. 4, the top housing 100 includes one or more sidewalls 106 and 108 having water-resistant inner surfaces 107 and 109. The water-resistant inner surfaces 107 and 109 of the top housing 100 are structured to be affixed to the water-resistant external surfaces 207 and 209 of the middle housing 200 so as to form water-resistant connections therebetween. In some embodiments, one or more corners 111 of the top housing 100 may include water-resistant structures 105, such as indents, cavities, and/or the like configured to engage with corresponding structures on the middle housing 200. Such water-resistant connections further reduce, minimize, or even completely eliminate the ingress of environmental elements into the compartment 10 by the water-resistant structure formed between the middle housing 200, the bottom housing 300, and the load and line terminals 40 and 20.

Accordingly, the water-resistant structure formed between the top housing 100, the middle housing 200, the bottom housing 300, and the load and line terminals 40 and 20 effectively reduces, minimizes, or even completely eliminates environmental element intrusion, for example, and without limitation, water droplet entry into the internal area of the GFCI outlet 1, thereby preventing any short circuit, faults, or other functional failures from occurring within the PCBA 2 or other internal outlet components.

Referring to FIGS. 6A and 6B, the top housing 100 includes a top side 101, having sidewalls extending downwardly therefrom, and a bottom side 102. The middle housing 200 includes a platform 205, a top or upper portion 201, and a bottom or lower portion 202. The bottom housing 300 includes a top or upper portion or side 302 and a bottom, lower, or base portion 301.

The middle housing 200 is affixed to the top housing 100 on the top surface 201 of the platform 205. The lower portion 202 includes water-resistant edges (for example, the water-resistant edges 1201 as shown in FIG. 3A) and non-water-resistant portion having projections (for example, the projections 2256 as shown in FIG. 3A) extending downwardly at an inner periphery of the water-resistant edges 1201. The lower portion 202 also includes middle corners and middle sidewalls extending downwardly at an outer periphery of the edges 1201 and adjoining respective middle corners.

The bottom housing 300 is affixed to the middle housing 200 on the bottom surface 202 of the platform 205. The bottom housing 300 includes bottom corners and bottom sidewalls extending upwardly from the base 301 and adjoining respective bottom corners. The base 301, the bottom corners and the bottom sidewalls form a compartment 10 structured to house the PCBA 2, circuit interruption mechanisms, and other electrical components. The lower portion 202 of the middle housing 200 is structured to cover the compartment 10.

In some embodiments, the load terminals 40 and line terminals 20 may be disposed within the compartment 10 and structured to be connected to respective load and power lines via connecting mechanisms 41 and 21. The middle housing 200, the bottom housing 300, and the load terminals 40 and line terminals 20 form a water-resistant structure that reduces or prevents the ingress of environmental elements into the compartment 10.

FIGS. 5A-7 depict the top housing 100, middle housing 200, bottom housing 300, and the load terminals 40 forming a water-resistant structure for the GFCI outlet 1. The terminal sidewalls 212, 214 312, and 314 of the middle housing 200 and the bottom housing 300 are structured to connect load and line terminals 40 and 20 to respective load and power lines via the connecting mechanism 41 and 21. Each terminal sidewall 212, 214 312, and 314 includes water-resistant recesses 1241, 1244, 1242, 1243, 1342, 1343, 1341, and 1344. As such, when the load and line terminals 40 and 20 are connected to respective load and power lines via the connecting mechanisms 41 and 21, the water-resistant recesses 1241, 1244, 1242, 1243, 1342, 1343, 1341, and 1344 interface with one another, the connecting mechanisms 41 and 21 and the load and line terminals 40 and 20 so as to form step-structured water-resistant connections there between. In addition, the water-resistant step-structured upper portions 1331 and 1337 of the bottom housing 300 engage with respective water-resistant edges 1201 and water-resistant side surfaces 1256a of the projections 2256 of the middle housing 200 so as to from additional step-structured water-resistant connections therebetween.

Step-structured water-resistant connection formed between the sub-housings 100, 200, and 300 (for example, and without limitation, the water-resistant step-structured upper portion 1323c of a bottom sidewall 314) and the middle housing (for example, and without limitation, the water-resistant edge 1201 and the water-resistant external side surface 1256a of the projection 2256). Such step-structured water-resistant connections include numerous water-resistant steps acting as a series of barriers, for instance, forming a tortuous path for environmental elements, against any environmental element ingress to the compartment 10 and prolonging the distances that need to be travelled by the environmental elements, such as moisture, water droplets, and/or the like.

Referring to FIG. 7, water-resistant structures according to some embodiments may be or may include step-structured configurations or joints. In some embodiments, a step-structure 701 may be formed from ridges 712 and 720 being arranged within corresponding (one-sided) grooves 710 and 722. Groove or horizontal surfaces 715 and 713 may interface with ridge or vertical surfaces 721 and 723 to form an interlocking connection 701 (for instance, a step structure). In some embodiments, the groove surfaces 715 and 713 and each corresponding one of the ridge surfaces 721 and 723 are orientated at ninety degrees with respect to each other. In various embodiments, ridge surfaces 721 and 723 are configured to abut against a corresponding one of the groove surfaces 715 and 713.

The step structure 701 may form a friction-fit and/or the like between sub-housings, for instance due to the friction between ridges 712 and 720 and grooves 710 and 722. The perimeter 303 of the middle housing 200 includes two ridges 720, one for the top housing 100 and one for the bottom housing 300, formed as inner walls or ridges of the perimeter 303. The perimeter 303 of the middle housing 200 includes two grooves 722, one for the top housing 100 and one for the bottom housing 300, formed as outer grooves of the perimeter 303. The ridges 712 of the top housing 100 and bottom housing 300 are formed as outer walls or ridges of each respective perimeter. The grooves 710 of the top housing 100 and bottom housing 300 are formed as inner grooves of each respective perimeter.

The friction-fit may provide water-resistance between sub-housings. The middle housing 200 is configured to form an interlocking step structure 701 connection with the top housing 100 and the bottom housing 300.

In some embodiments, the step structure 701 may operate to provide a tortuous path between sub-housings for the ingress of environmental elements to provide and/or to further facilitate water-resistance between sub-housings. For example, a wall (for instance, groove 722) may be directly behind each seam (e.g., 90). In another example, for seam 90, a tortuous path may be formed via structures 723, 722, and 715. Accordingly, for moisture, water droplets, or other environmental elements to enter a seam in the housing 15, it must travel past the corresponding ridges and grooves in order to penetrate the interior of the housing 15 (such as the compartment 10) which may not be possible under typical environmental conditions, including when exposed to moisture or other environmental elements.

For example, in reference to the bottom housing 300, water-resistant step-structured upper portions 1342b, 1343b, 1341b, and 1344b and water-resistant step-structured lower portions 1342d, 1343d, 1341d, and 1344d are configured as step-structured configured to form a step structure 701 with corresponding structures of the middle housing 200 (external surfaces 1256a and water-resistant bottom surfaces 1222a, 1222b, 1222c, and 1222d).

While specific embodiments have been described in detail, it will be appreciated by those skilled in the art that various modifications and alternatives to those details could be developed in light of the overall teachings of the present disclosure. Accordingly, the particular arrangements disclosed are meant to be illustrative only and not limiting as to the scope of disclosed concept which is to be given the full breadth of the claims appended and any and all equivalents thereof.

What is claimed is:

1. A water-resistant housing assembly for an electrical outlet, comprising:
a top housing having a top housing perimeter;
a bottom housing having a bottom housing perimeter, the bottom housing perimeter and the top housing perimeter formed with respective outer ridges and inner grooves; and
a middle housing having a top middle perimeter formed on a top side of the middle housing and a bottom middle perimeter arranged on a bottom side of the middle housing, the top middle perimeter and the bottom middle perimeter comprising respective inner ridges and outer grooves,
wherein the middle housing is configured to:
form a first connection to the top housing in a first water-resistant connection via forming a first interlocking step structure between the inner ridges and the outer grooves of the top middle perimeter and the outer ridges and the inner grooves of the top housing perimeter, and
form a second connection to the bottom housing in a second water-resistant connection via forming a second interlocking step structure between the inner ridges and the outer grooves of the bottom middle perimeter and the outer ridges and the inner grooves of the bottom housing perimeter.

2. The water-resistant housing assembly for an electrical outlet the claim 1, wherein each of the inner ridges and each corresponding one of the inner grooves are orientated at ninety degrees with respect to each other.

3. The water-resistant housing assembly for the electrical outlet of claim 1, wherein:
external seams are formed at the first connection and the second connection, and
the inner ridges and outer grooves form a tortuous path for environmental elements to enter an interior of the water-resistant housing assembly.

4. The water-resistant housing assembly for the electrical outlet of claim 1, wherein the middle housing and the bottom housing form a compartment configured to house electrical components of the electrical outlet.

5. The water-resistant housing assembly for the electrical outlet of claim 1, each of the inner ridges and the outer ridges include ridge surfaces are configured to abut against corresponding groove surfaces of the inner grooves and the outer grooves.

6. The water-resistant housing assembly for the electrical outlet of claim 1, wherein:
the bottom housing comprises a bottom sidewall extending longitudinally upward from a base of the bottom housing, the bottom sidewall having a water-resistant bottom recess,
the middle housing includes a water-resistant middle recess arranged in a middle sidewall of the middle housing, and
the water-resistant bottom recess and the water-resistant middle recess configured to be coupled to form a water-resistant recess for a connecting mechanism of a terminal arranged within the electrical outlet.

7. The water-resistant housing assembly for the electrical outlet of claim 6, wherein:
the water-resistant middle recess includes a first water-resistant surface and a first water-resistant step-structured bottom portion, and
the water-resistant bottom recess includes a second water-resistant surface and a second water-resistant step-structured bottom portion.

8. The water-resistant housing assembly for the electrical outlet of claim 7, wherein the first water-resistant surface, the first water-resistant step-structured bottom portion, the second water-resistant surface, and the second water-resistant step-structured bottom portion are configured to form a water-resistant step structure.

9. The water-resistant housing assembly for the electrical outlet of claim 6, wherein the water-resistant middle recess comprises water-resistant teeth and water-resistant inner surfaces configured to correspond with upper contours of the terminal to prevent a gap between the terminal and the middle recess.

10. An electrical outlet, comprising:
a top housing;
a bottom housing including a base, bottom corners, and bottom sidewalls extending upwardly from the base, the base, the bottom corners and the bottom sidewalls forming a compartment structured to house electrical components of the electrical outlet;
a middle housing having a platform including middle corners and middle sidewalls extending longitudinally downward from the platform, the middle housing coupled to the top housing on a top surface of the platform and coupled to the bottom housing on a bottom surface of the platform, the middle housing being structured to cover the compartment; and
load terminals arranged within the compartment and configured to be coupled to connecting mechanisms,
wherein the top housing, the middle housing, and the bottom housing are coupled via interlocking step structures to form a water-resistant structure.

11. The electrical outlet of claim 10, wherein the bottom sidewalls comprise water-resistant bottom recesses structured to receive the connecting mechanisms and the middle sidewalls comprise water-resistant middle recesses structured to receive upper portions of the connecting mechanisms, the water-resistant bottom recesses and the water-resistant middle recesses to form a portion of the water-resistant structure.

12. The electrical outlet of claim 11, wherein the water-resistant bottom recesses of the bottom sidewalls include water-resistant surfaces and water-resistant step-structured upper portions, and wherein the water-resistant middle recesses of the middle sidewalls include water-resistant surfaces and water-resistant step-structured bottom portions.

13. The electrical outlet of claim 12, wherein the water-resistant surfaces of the bottom recesses are structured to engage with the connecting mechanisms, the load terminals, and respective water-resistant surfaces of the middle recesses to form a portion of the water-resistant structure.

14. The electrical outlet of claim 12, wherein the water-resistant step-structured upper portions of the bottom recesses are structured to engage with the water-resistant step-structured bottom portions of the middle recesses to form a portion of the water-resistant structure.

15. The electrical outlet of claim 11, wherein the bottom corners comprise water-resistant step-structured upper portions each including water-resistant surfaces, wherein the middle corners comprise water-resistant bottom surfaces, and wherein the platform includes water-resistant edges on the bottom surface of the platform and non-water-resistant projections extending downwardly at an inner periphery of the water-resistant edges, the non-water-resistant projections including water-resistant external side surfaces.

16. The electrical outlet of claim 15, wherein the water-resistant step-structured upper portions of the bottom corners are structured to engage with the water-resistant bottom surfaces of the middle corners and the water-resistant external side surfaces of the non-water-resistant projections of the platform to form a portion of the water-resistant structure.

17. The electrical outlet of claim 10, wherein the water-resistant structure has a step-structure including a plurality of water-resistant steps configured to operate as a tortuous path for environmental elements to ingress into the housing assembly.

18. A ground fault circuit interrupter (GFCI) outlet, comprising:
a load terminal and a line terminal; and
a water-resistant housing assembly having the load terminal and the line terminal arranged therein, the water-resistant housing assembly comprising:
a top housing having a top housing perimeter;
a bottom housing having a bottom housing perimeter, the bottom housing perimeter and the top housing perimeter formed with respective outer ridges and inner grooves; and
a middle housing having a top middle perimeter formed on a top side of the middle housing and a bottom middle perimeter arranged on a bottom side of the middle housing, the top middle perimeter and the bottom middle perimeter comprising respective inner ridges and outer grooves,
wherein the middle housing is configured to:
form a first connection to the top housing in a first water-resistant connection via forming a first interlocking step structure between the inner ridges and the outer grooves of the top middle perimeter and the outer ridges and the inner grooves of the top housing perimeter, and
form a second connection to the bottom housing in a second water-resistant connection via forming a second interlocking step structure between the inner ridges and the outer grooves of the bottom middle perimeter and the outer ridges and the inner grooves of the bottom housing perimeter,
wherein the bottom housing comprises includes a water-resistant bottom recess and the middle housing includes a water-resistant middle recess, the water-resistant bottom recess and the water-resistant middle recess configured to be coupled to form a water-resistant recess for a connecting mechanism of one of the load terminal or the line terminal.

19. The GFCI outlet of claim 18, wherein:
external seams are formed at the first connection and the second connection, and
the inner ridges and outer grooves form a tortuous path for environmental elements to enter an interior of the water-resistant housing assembly.

20. The GFCI outlet of claim 18, wherein the middle housing and the bottom housing form a compartment configured to house electrical components of the electrical outlet.
